(19) United States
(12) Patent Application Publication
(10) Pub. No.: US 2016/0012791 A1
(43) Pub. Date: Jan. 14, 2016

(54) LIQUID CRSYTAL DISPLAY DRIVING METHOD

(71) Applicant: Jadard Technology Inc., Tainan (TW)

(72) Inventors: Wen-Yi HSIEH, Tainan (TW); Chao-Cheng WU, Tainan (TW); Wei-Lin CHUANG, Tainan (TW)

(73) Assignee: Jadard Technology Inc., Tainan (TW)

(21) Appl. No.: 14/517,938

(22) Filed: Oct. 20, 2014

(30) Foreign Application Priority Data
Jul. 9, 2014 (TW) 103123707

(51) Int. Cl. G09G 3/36

(52) U.S. Cl. CPC G09G 3/3648; G09G 3/3674; G09G 2310/0224; G09G 2330/021

(57) ABSTRACT

A liquid crystal display driving method is disclosed, where an interlaced image data is received or generated to generate an odd driving signal and an even driving signal, an odd number of gates and an even number of gates are driven according to the odd driving signal and the even driving signal at different signal frame periods, and sources are driven to inverse in their polarities when the driven gates are switched from the ones having the odd number to the even number. Since an alternating number of the sources is reduced, the efficacy of simultaneous promoted power saving and frame quality is achieved.

### CROSS-REFERENCE TO RELATED APPLICATIONS

The present application claims the benefit of TAIWAN Patent Application Serial Number 103123707, filed on Jul. 9 2014, which are herein incorporated by reference.

### BACKGROUND OF RELATED ART

1. Technical Field

The present invention relates to a display driving method, and particularly to a liquid crystal display driving method where a gate driving manner is altered to reduce an alternating time of a source to save power consumption and maintain image quality.

2. Related Art

For recent years, with wide prevalence and vigorous development of liquid crystal displays (LCDs), they have replaced traditional cathode ray tubes (CRTs) as main displays. Since LCDs and the CRTs have different structures, they have different drive manners. For LCDs, they display based on their liquid crystal molecular structures and optical characteristics. The liquid crystal molecular requires to be driven by an AC signal, preventing the electric and chemical characteristics of their liquid crystal molecular from being affected, resulting in some irreversible issues such as a vague frame and a shortened lifetime.

At present, the liquid crystal molecular may be altered its orientations by using an output signal of a driver IC, which sequentially forms an overall display frame. The driver IC mainly comprises a gate driving portion and a source driving portion. The gate driving is used to activate or inactivate a switch associated with the liquid crystal, so that each row of the LCD may be controlled for its switch action. When the LCD is sequentially scanned row by row, its gates may be activated and thus an image data is inputted from its sources. Namely, when a gate is activated, an overall row of switch will be opened, while an image data is inputted into the source associated therewith to display the image.

Besides the structural difference, the LCD also has a higher processing speed and a larger bandwidth as compared to the CRT. Generally, since the traditional CRT has the limit of the processing speed and the bandwidth, interlaced image data is used to display the images. However, the LCD uses instead serial image data to display the images. If the interlaced image data is directly used to be displayed on the LCD, it may not have a normal display work. Hence, in the LCD, an additional conversion circuit has to be provided to convert the interlaced image data into the serial image data to display images normally. However, this conversion circuit may involve an increased power consumption of the LCD.

In addition, consider the liquid crystal's characteristics, the output of the source has to be inversed in its polarity. The different polarities inversion manners correspond to different drive manners, and include “one-dot inversion”, “two-dot inversion” and “column inversion” manners. Among them, the “one-dot inversion” manner is the most commonly used one, and by which each row in the LCD has an opposite polarity to that of its adjacent rows. For the “two-dot inversion” manner, two rows are grouped as one set and have the same polarity while each set adjacent to each other has the opposite polarity. In the case of the column inversion manner, each row in a frame has the same polarity, while adjacent frames have the different polarities.

In other words, these three drive manners differs in their time points and numbers of polarity reversion. The larger the inversion number is, the better the frame quality is and the larger the power consumption is.

Take the column inversion as an example, since the sources in each row have the same polarity while the sources in two adjacent rows have the opposite polarities In this case, if the voltages of the different polarities have an error, a flicker phenomenon is possible to be caused, which may result in an undesirable effect on the frame quality.

In terms of this issue, some particular liquid crystal panels, such as “Zig-Zag panel”, have been proposed. In this scheme, the electric connection manner in the liquid crystal is improved to change the driven liquid crystal laterally continuously. Hence, the liquid crystal in this panel has the same polarity distribution with that of the one-dot manner and thus has a good frame quality. In addition, its source has the same inversion number with that of the column inversion manner, lending to a lower power consumption.

In other words, this scheme does not change the drive manner for driving the IC but only the liquid crystal panel. However, alternation of the liquid crystal panel may largely increase the production cost, and may not be applied onto the conventional liquid crystal panel. Therefore, when the conventional liquid crystal panel is used, the issue that the decreased power consumption and the frame quality maintenance may not be secured simultaneously are still presented.

In view of the above, it may be known that there has long been the issue of that the decreased power consumption and the frame quality maintenance may not be secured simultaneously. Therefore, there is quite a need to provide a technical means to overcome this problem.

### SUMMARY

The present invention discloses a liquid crystal display driving method.

According to the present invention, the liquid crystal display driving method comprises steps of receiving sequentially a plurality of signal frames, each being a serial image data; converting the serial image data into an interlaced image data; generating an odd driving signal and an even driving signal according to the interlaced image data; activating one of a plurality of gates having an odd number sequentially according to the odd driving signal when the plurality of signal frames have the odd number and activating one of a plurality of gates having an even number sequentially according to the even driving signal when the plurality of signal frames have the even number, wherein when the plurality of signal frames are switched from having the odd number to the even number, a plurality of sources are each driven to have an inversed polarity, respectively; and displaying continuously the plurality of signal frames to display an image, respectively, according to a state of the plurality of gates having the odd number and the even number and the plurality of sources continuously.

According to the present invention, the liquid crystal display driving method comprising steps of receiving sequentially a plurality of signal frames, each being a serial image data; converting the serial image data into an interlaced image data; generating an odd driving signal and an even driving signal according to the interlaced image data; activating one of a plurality of gates having an odd number sequentially according to the odd driving signal at a first half period of each of the plurality of signal frames, and activating one of a plurality of gates having an even number sequentially according to the even driving signal at a second half period of each of the plurality of signal frames, wherein when the first half period is switched to the second half period, a plurality of sources are each driven to have an inversed polarity, respectively; and displaying continuously the plurality of signal frames to display an image, respectively, according to a state of the plurality of gates having the odd number and having the even number and the plurality of sources continuously.

According to the present invention, the liquid crystal display driving method comprises steps of receiving sequentially a plurality of signal frames, each being an interlaced image data; generating an odd driving signal and an even driving signal according to the interlaced image data; activating one of a plurality of gates having an odd number sequentially according to the odd driving signal at the plurality of signal frames having the odd number, and activating one of a plurality of gates having an even number sequentially according to the even driving signal at the plurality of signal frames having the even number, wherein when the plurality of signal frames are switched from having the odd number to the even number, a plurality of sources are each driven to have an inversed polarity, respectively; and displaying continuously the plurality of signal frames to display an image, respectively, according to a state of the plurality of gates having the odd number and having the even number and the plurality of sources continuously.

According to the present invention, the liquid crystal display driving method comprises steps of receiving sequentially a plurality of signal frames, each being an interlaced image data; generating an odd driving signal and an even driving signal according to the interlaced image data; activating one of a plurality of gates having an odd number sequentially according to the odd driving signal at a first half period of each of the plurality of signal frames, and activating one of a plurality of gates having an even number sequentially according to the even driving signal at a second half period of each of the plurality of signal frames, wherein when the first half period is switched to the second half period, a plurality of sources are each driven to have an inversed polarity, respectively; and displaying continuously the plurality of signal frames to display an image, respectively, according to a state of the plurality of gates having the odd number and having the even number and the plurality of sources.

According to the present invention, the liquid crystal display driving method comprises steps of receiving sequentially a plurality of signal frames each comprising a plurality of odd row image data and a plurality of even row image data; activating one of a plurality of gates having an odd number sequentially and transmitting the plurality of odd row image data to a plurality of sources at the plurality of signal frames having the odd number, and activating one of a plurality of gates having an even number sequentially and transmitting the plurality of even row image data to the plurality of sources at the plurality of signal frames having the even number, wherein when the plurality of signal frames are switched from having the odd number to the even number, a plurality of sources are each driven to have an inversed polarity, respectively; and displaying continuously the plurality of signal frames to display an image, respectively, according to a state of the plurality of gates having the odd number and having the even number and the plurality of sources.

The present invention has the difference as compared to the prior art that the interlaced image data is received or generated to generate the odd driving signal and the even driving signal, the odd number of gates and the even number of gates are driven according to the odd driving signal and the even driving signal at different signal frame periods, and the sources are driven to inverse in their polarities when the driven gates are switched from the ones having the odd number to the even number, so that an interlacing number of the sources may be reduced.

By busing of this technical means, the efficacy of simultaneous promoted power saving and frame quality may be achieved.

### BRIEF DESCRIPTION OF THE DRAWINGS

The present invention will be better understood from the following detailed descriptions of the preferred embodiments according to the present invention, taken in conjunction with the accompanying drawings, in which:

FIG. 1 is a schematic diagram of driving a gate of a conventional liquid crystal panel according to the present invention;

FIG. 2 is a flowchart of a liquid crystal display driving method of according to a first embodiment of the present invention;

FIG. 3 is a flowchart of the liquid crystal display driving method of according to a second embodiment of the present invention;

FIG. 4 is a flowchart of the liquid crystal display driving method of according to a third embodiment of the present invention;

FIG. 5 is a flowchart of the liquid crystal display driving method of according to a fourth embodiment of the present invention;

FIG. 6 is a flowchart of the liquid crystal display driving method of according to a fifth embodiment of the present invention;

FIG. 7 and FIG. 8 are schematic diagrams illustrating a conversion from a serial image data to interlaced image data according to the present invention;

FIG. 9 is a schematic diagram of a first waveform obtained by using the liquid crystal display driving method according to the present invention; and

FIG. 10 is a schematic diagram of a second waveform obtained by using the liquid crystal display driving method according to the present invention.

### DETAILED DESCRIPTION

The present invention will be apparent from the following detailed description, which proceeds with reference to the accompanying drawings, wherein the same references relate to the same elements.

Prior to the description of the liquid crystal display driving method of the present invention, the environment the present invention is applied onto and the nouns privately defined in the present invention are explained first. The present invention is applied onto LCD drive ICs, and drives gates in an interlaced manner, enables sources to inverse in their polarities when the driven gates are switched from the ones having the odd number to the even number, and thus effectively reduces an alternating number of the sources, whereby achieving the effect of simultaneous power consumption reduction and good frame quality. As for the odd driving signal and the even driving signal, they are the ones driving the odd number of gates and the even number of gates, respectively.

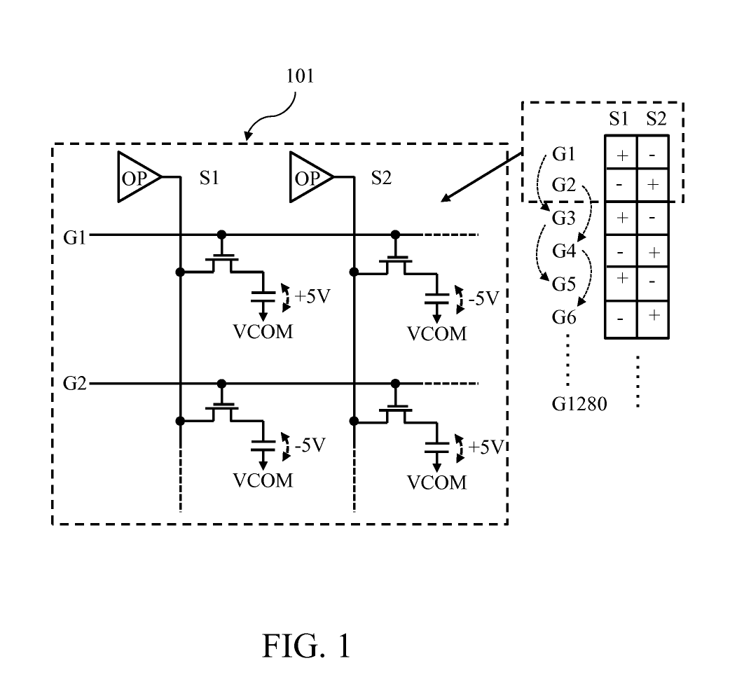

In the following, the liquid crystal display driving method according to the present invention will be described in more details. Referring to FIG. 1, in which a schematic diagram of driving a gate of a conventional liquid crystal panel according to the present invention is shown. The liquid crystal panel 101 has a plurality of gates, such as G1, G2, . . . , Gn, and a plurality of sources, such as S1, S2, . . . , Sn. Conventionally, the gates of the liquid crystal panel are driven according to the subsequence of G1, G2, . . . , to Gn. However, in present invention, the liquid crystal panel is driven the odd number of gates first, such as G1, G3, G5 . . . , to Gn−1, and then the even number of gates, such as, G2, G4, G6 . . . , to Gn. In this manner, the gates are driven in an alternating drive manner.

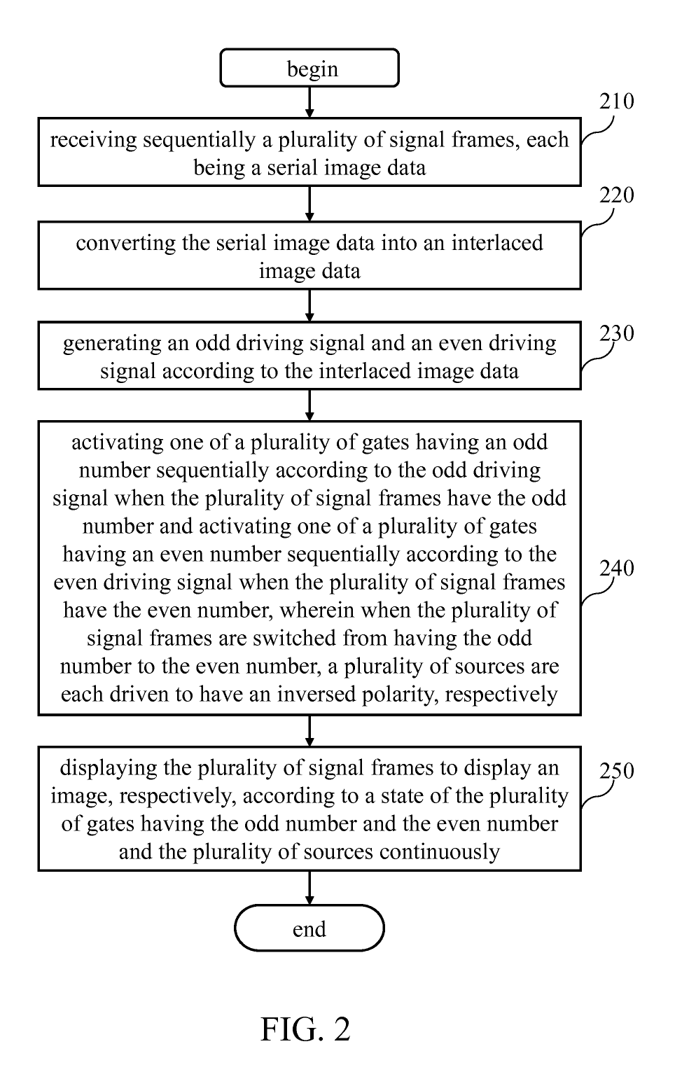

Thereafter, referring to FIG. 2, in which a flowchart of a liquid crystal display driving method of according to a first embodiment of the present invention is shown. The method comprises the following steps. Firstly, a plurality of signal frames, each being a serial image data are received (Step 210). Next, the serial image data into an interlaced image data is conversed (Step 220). Thereafter, an odd driving signal and an even driving signal are generated according to the interlaced image data (Step 230). Then, one of a plurality of gates having an odd number sequentially according to the odd driving signal when the plurality of signal frames have the odd number is activated and one of a plurality of gates having the even number sequentially according to the even driving signal when the plurality of signal frames have the even number is activated, wherein when the plurality of signal frames are switched from having the odd number to the even number, a plurality of sources are each driven to have an inversed polarity, respectively (Step 240). Finally, the plurality of signal frames are displayed to display an image, respectively, according to a state of the plurality of gates having the odd number and the even number and the plurality of sources continuously (Step 250).

By using the above steps, the odd driving signal may be issued at the signal frames having the odd number. At this time, the sources having the odd number only update their data when the gates having the odd number are driven and the update maintains a period until a next signal frame, i.e. a signal frame having the odd number. At the signal frame having the even number, the even driving signal is issued. At this time, the sources having the even number only update their data when the gates having the even number are driven and the update maintains a period until a next signal frame, i.e. a signal frame having the even number. It is to be noted that since only the signal frames having the odd number update the liquid crystal and the signal frames having the even number does not update the liquid crystal, the update frequency of the odd row is only 30 Hz. If the same liquid crystal frequency is desired, a frame frequency has to be promoted to 120 Hz, so that the liquid crystal update frequency may reach 60 Hz. This belongs to a scope of the prior art, and thus omitted herein for clarity. In addition, although the gates having the odd and even number are activated at the signal frames having the odd and even number, respectively, in the first embodiment, the gates having the odd number may also be instead activated at the signal frames having the even number, and the gates having the even number are activated at the signal frames having the odd number.

In addition, in real implementation, the serial image data in the step 220 is subject to a masking process to form an interlaced image data. For example, the even row data is subject to the masking process first, and only the odd row data is transmitted. Next, the odd row data is subject to the masking process first, and only the even row data is transmitted.

Thereafter, the interlaced image data may be transmitted sequentially to each of the sources. The interlaced image data may generate the odd driving signal at the signal frames having the odd number and the even driving signal at the signal frames having the even number. In real implementation, in the step 240, one of the gates having the odd number may be sequentially activated downwards or upwards according to the odd driving signal, and one of the gates having the even number may be sequentially activated downwards or upwards according to the even driving signal.

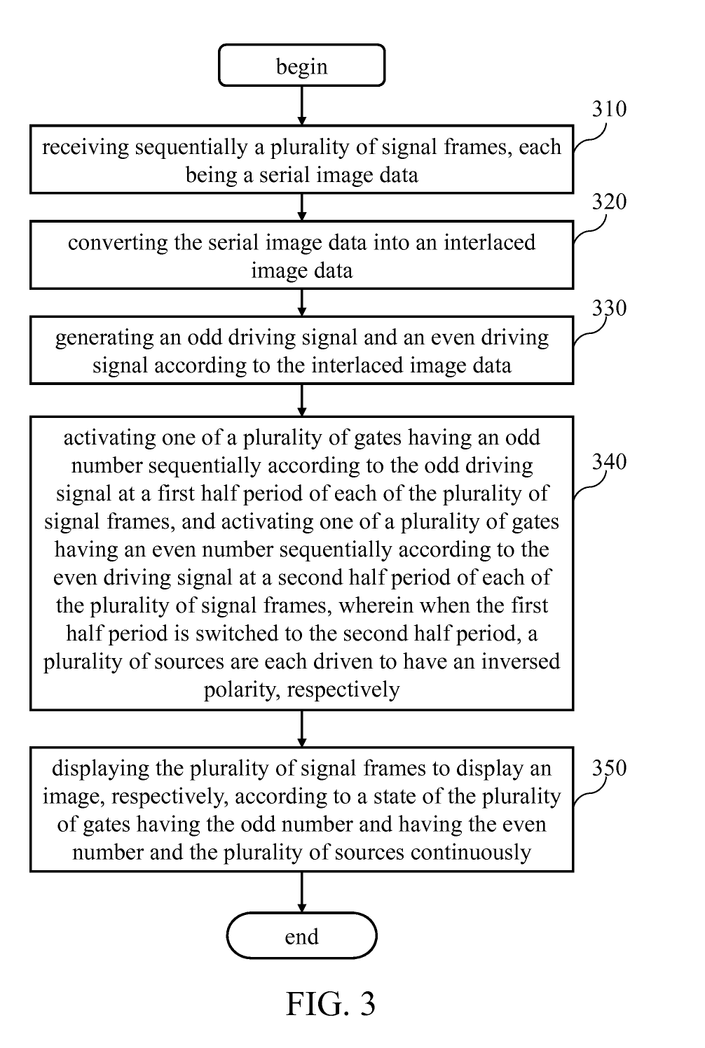

Referring to FIG. 3, in which a flowchart of the liquid crystal display driving method of according to a second embodiment of the present invention is shown. The method comprises the following steps. First, a plurality of signal frames, each being a serial image data are received sequentially (Step 310). Next, the serial image data into an interlaced image data (Step 320). Thereafter, an odd driving signal and an even driving signal are generated according to the interlaced image data (Step 330). Thereafter, one of a plurality of gates having the odd number is sequentially generated according to the odd driving signal at a first half period of each of the plurality of signal frames, and one of a plurality of gates having the even number is sequentially generated according to the even driving signal at a second half period of each of the plurality of signal frames, wherein when the first half period is switched to the second half period, a plurality of sources are each driven to have an inversed polarity, respectively (Step 340). Finally, the plurality of signal frames to display an image are displayed, respectively, according to a state of the plurality of gates having the odd number and having the even number and the plurality of sources continuously (Step 350).

By using the above steps, at the first half period of the signal frame, the gate issues a control signal, i.e. the odd driving signal. Further, the source associated with the source updates its data and maintains its polarity. At the second half period of the same signal frame, the gate issues a control signal, i.e. the even driving signal. Further, the source associated with the source updates its data and changes its polarity to be opposite to that at the first half period of the signal frames. Since only one time of polarity change at the second half period of the signal frame, the alternating number of the source is effectively reduced, achieving a power saving result. Further, since the two adjacent rows of liquid crystal have different polarities, the frame quality may be maintained owing to the different polarities of liquid crystal. Although the gate having the odd number in the second embodiment is activated at the first half period of each of the signal frames, and the gate having the even number is activated at the second half period of each of the signal frames, the gate having the odd number may be instead activated at the second half period of each of the signal frames and the gate having the even number is instead activated at the first half period of each of the signal frames correspondingly.

In real implementation, the step 320 stores the serial image data in a memory, such as a graphic memory, and rearranges the odd and even rows of serial image data into an interlaced image data. For example, the odd number row of the serial image data is first extracted in the step 320 and rearranged as the first half portion of the interlaced image data. Next, the even number rows of the serial image data are extracted and rearranged as the second half portion of the interlaced image data. In this manner, the first and second half portions of the interlaced image data may be composed of the complete interlaced image data. Thereafter, the interlaced image data in the memory may be sequentially transmitted to each of the sources. The interlaced image data generates the odd driving signal at the transmitted first half period and the even driving signal at the transmitted second half period. In real implementation, in the step 340, the odd driving signal activate one of plurality of gates having the odd number downward or upward sequentially, and the even driving signal activate one of the plurality of gates having the even number downward or upward sequentially.

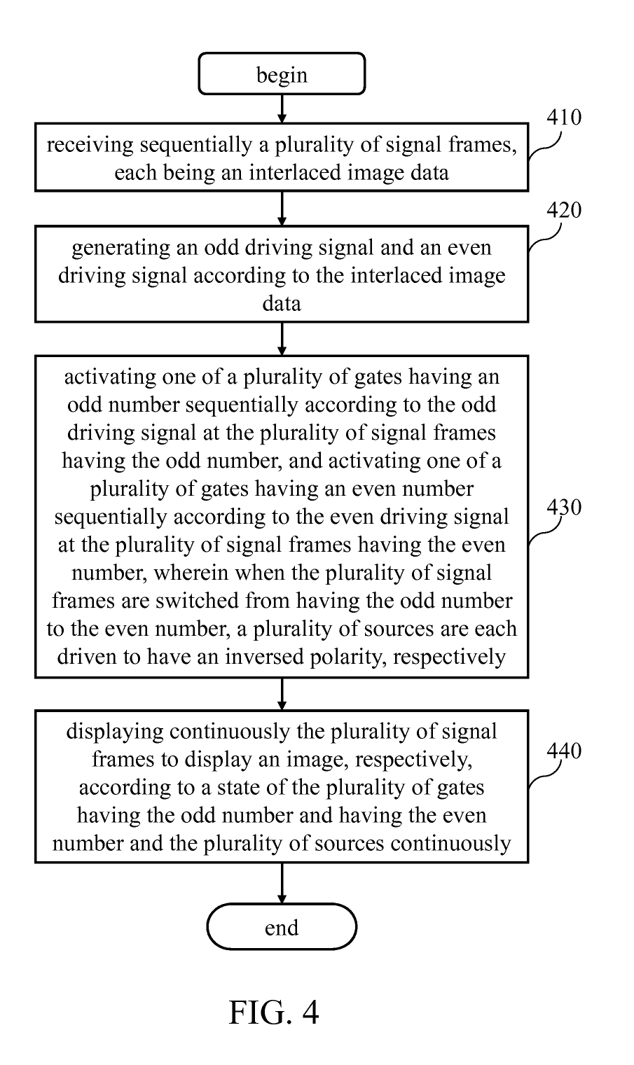

Referring to FIG. 4, a flowchart of the liquid crystal display driving method of according to a third embodiment of the present invention is shown therein. The method comprises the following steps. First, a plurality of signal frames, each being an interlaced image data are received (Step 410). Next, an odd driving signal and an even driving signal are generated according to the interlaced image data (Step 420). Then, one of a plurality of gates having the odd number sequentially is activated according to the odd driving signal at the plurality of signal frames having the odd number, and one of a plurality of gates having the even number sequentially is activated according to the even driving signal at the plurality of signal frames having the even number, wherein when the plurality of signal frames are switched from having the odd number to the even number, a plurality of sources are each driven to have an inversed polarity, respectively (Step 430). Finally, displaying continuously the plurality of signal frames to display an image, respectively, according to a state of the plurality of gates having the odd number and having the even number and the plurality of sources (Step 440).

The third embodiment has the main difference as compared to the first embodiment that the interlaced image data is directly received without any conversion required. In the third embodiment, the frame rate of the signal frames may be the same as that of the first embodiment of 120 Hz. The interlaced image data is also transmitted by the sources. And, at the signal frames having the odd number, the odd driving signal is generated, and the even driving signal is generated at the signal frames having the even number.

In real implementation, in the step 420, the odd number or even number rows of serial image data are first subject to a masking process to form the interlaced image data. For example, the even number row is first subject to the masking process and only the odd number row of data is transmitted. Thereafter, the odd number row of data is subject to the masking process, and only the even row of data is transmitted.

In this manner, at the signal frames having the odd number may the odd number row of image data display, and at the signal frames having the even number may the even number row of image data display. And, the adjacent odd signal frames and the even signal frames present an overall display frame. In addition, the step 430 may activate one of the plurality of odd number gates upwards or downwards according to the odd driving signal, and one of the plurality of even number gates upwards or downwards according to the even driving signal. It is to be particularly pointed out that although the gates having the odd and even number are activated at the signal frames having the odd and even number, respectively, in the third embodiment, the gates having the odd number may also be instead activated at the signal frames having the even number, and the gates having the even number are activated at the signal frames having the odd number.

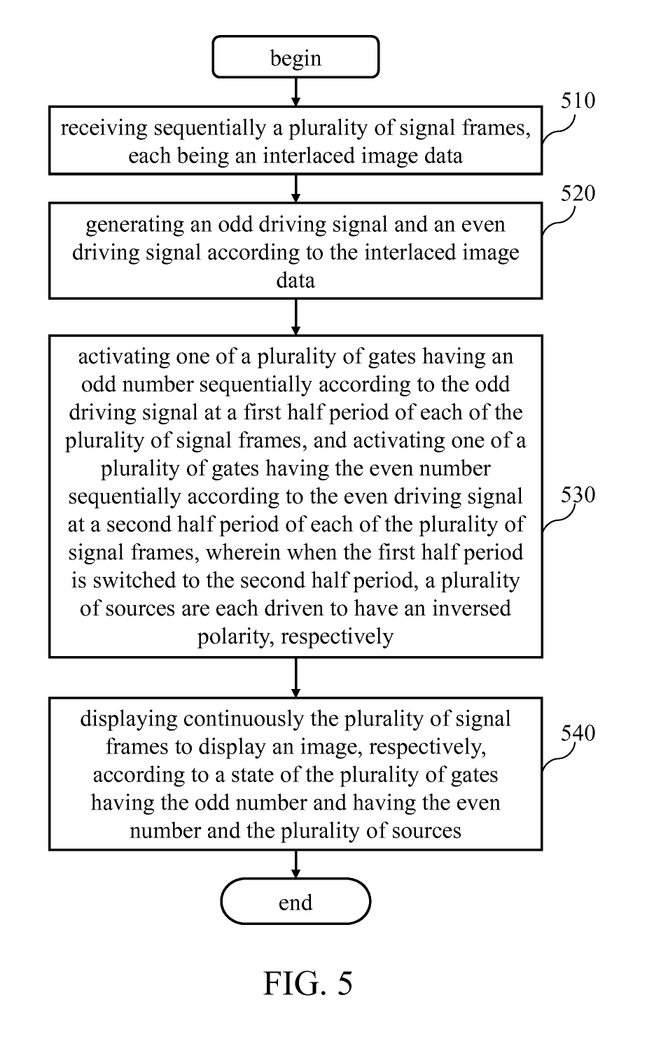

Referring to FIG. 5, in which a flowchart of the liquid crystal display driving method of according to a fourth embodiment of the present invention. The method comprises the following steps. First, a plurality of signal frames, each being an interlaced image data, is sequentially received (Step 510). Next, an odd driving signal and an even driving signal are generated according to the interlaced image data (Step 520). Thereafter, at a first half period of each of the plurality of signal frames, one of a plurality of gates having the odd number is sequentially activated according to the odd driving signal, and one of a plurality of gates having the even number is sequentially activated according to the even driving signal at a second half period of each of the plurality of signal frames, wherein when the first half period is switched to the second half period, a plurality of sources are each driven to have an inversed polarity, respectively (Step 530). Finally, the plurality of signal frames are displayed continuously to display an image, respectively, according to a state of the plurality of gates having the odd number and having the even number and the plurality of sources (Step 540).

By using the above steps, at the first half period of each of the plurality of signal frames, the gate issues a control signal, i.e. the odd driving signal, to drive the gate having the odd number, and the source associated with the gate update the data and maintain its polarity, and at the second half period of each of the plurality of signal frames, the gate issues a control signal, i.e. the even driving signal, to drive the gate having the even number, and the source associated with the gate update the data and change its polarity to be opposite to that at the first half period of the signal frames. Since only one time of polarity change at the second half period of the signal frame, the alternating number of the source is effectively reduced, achieving a power saving result. Further, since the two adjacent rows of liquid crystal have different polarities, the frame quality may be maintained owing to the different polarities of liquid crystal. In other words, the fourth embodiment has the main difference as compared to the second embodiment that the interlaced image data is directly received without any conversion required. In this fourth embodiment, the interlaced image data is also transmitted by the sources, and the odd driving signal is generated at the first half period of each of the plurality of signal frames and the even driving signal is generated at the second half period of each of the plurality of signal frames, in the course of transmission of the interlaced image data. In real implementation, in the step 530, the odd driving signal activate one of plurality of gates having the odd number downward or upward sequentially, and the even driving signal activate one of the plurality of gates having the even number downward or upward sequentially. Although the gate having the odd number in the fourth embodiment is activated at the first half period of each of the signal frames, and the gate having the even number is activated at the second half period of each of the signal frames, the gate having the odd number may be instead activated at the second half period of each of the signal frames and the gate having the even number is instead activated at the first half period of each of the signal frames correspondingly.

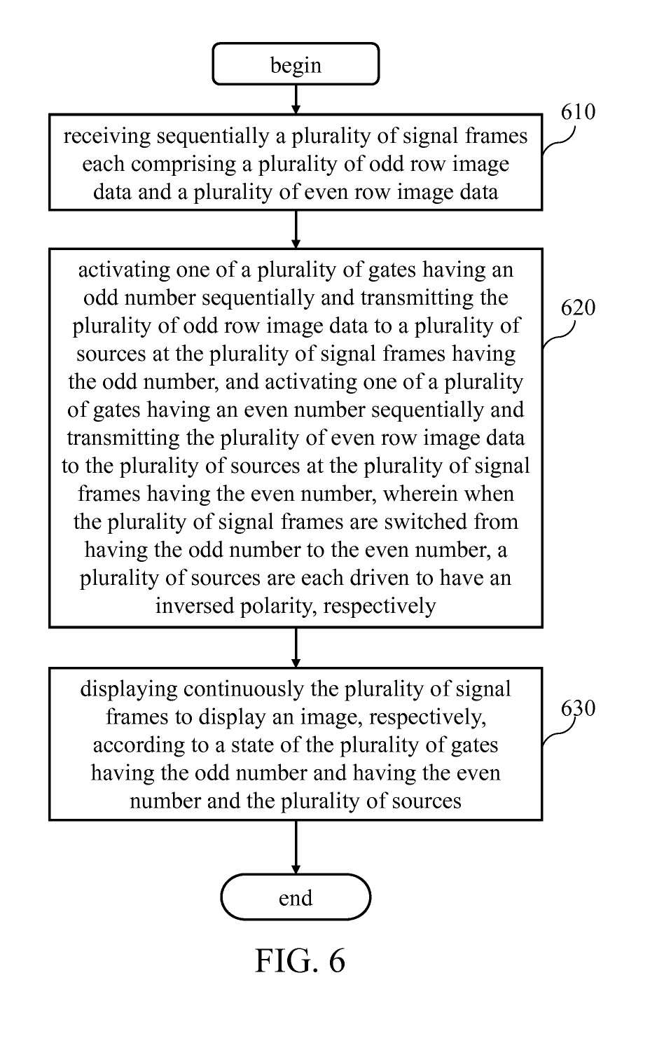

Referring to FIG. 6, in which a flowchart of the liquid crystal display driving method of according to a fifth embodiment of the present invention is shown. The method comprises the following steps. First, a plurality of signal frames each comprising a plurality of odd row image data and a plurality of even row image data are sequentially received (Step 610). Next, one of a plurality of gates having the odd number is sequentially activated according to the odd driving signal and the plurality of odd row image data are transmitted to a plurality of sources at the plurality of signal frames having the odd number, and one of a plurality of gates having the even number is sequentially activated according to the even driving signal and the plurality of even row image data are transmitted to the plurality of sources at the plurality of signal frames having the even number, wherein when the plurality of signal frames are switched from having the odd number to the even number, the plurality of sources are each driven to have an inversed polarity, respectively (Step 620). Finally, sources of even row image data are transmitted to the plurality of signal frames are displayed continuously to display an image, respectively, according to a state of the plurality of gates having the odd number and having the even number and the plurality of sources (Step 630).

In the fifth embodiment, each of the plurality of signal frames only displays half of the image data. For example, the odd number row of image data or the even number row of image data is displayed. To avoid from a reduction of the image quality owing to the half data display, the frame rates of the signal frames may be set as 120 Hz in the course of displaying the signal frame in the step 630, so that two consecutive signal frames may be composed to from a complete static image, and consecutive static images are used to present a dynamic image, such as video. In addition, in real implementation, in the step 630, the odd driving signal activate one of plurality of gates having the odd number downward or upward sequentially, and the even driving signal activate one of the plurality of gates having the even number downward or upward sequentially.

As stated above, the present invention may generate the odd driving signal and the even driving signal by receiving or generating the interlaced image data, and drive the gates having the odd number and the even number at different signal frames according to the odd driving signal and the even number, and inverses the polarity of the sources when the driven gates is switched from ones having the odd number to the even number. In this manner, the alternating number of the sources may be reduced, and the adjacent liquid crystals have different polarities, whereby achieving a power saving result and a good frame quality simultaneously.

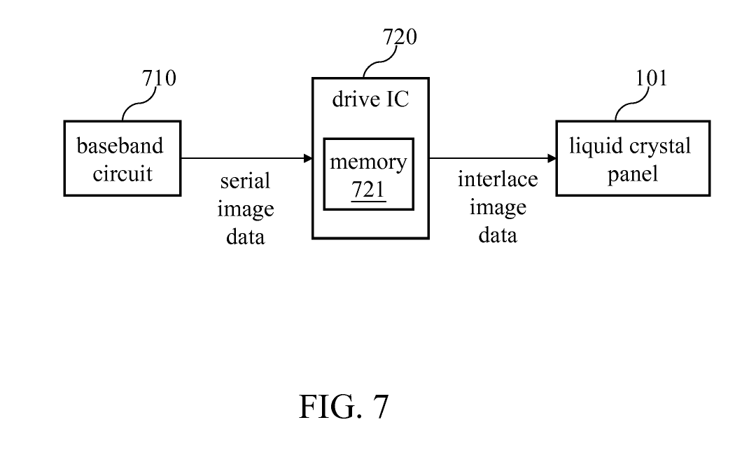

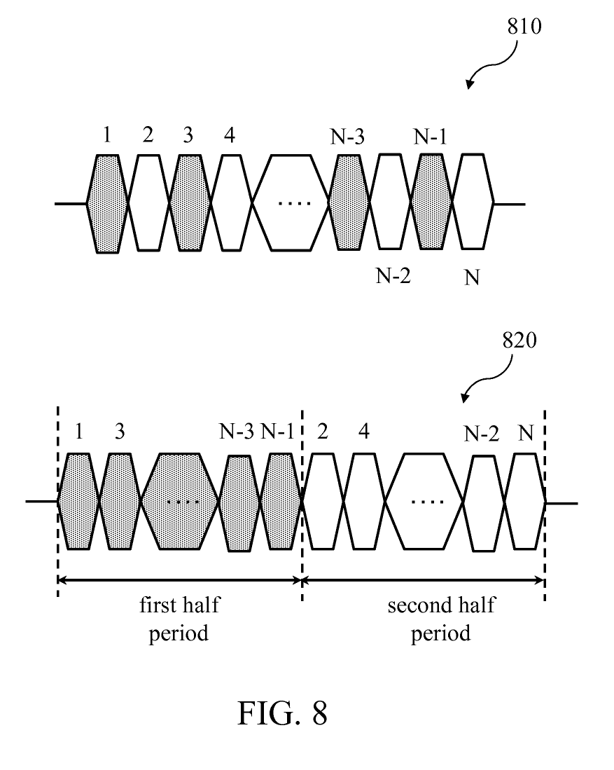

In the following, FIG. 7 through FIG. 10 are set forth to proceed the description. Referring to FIG. 7 and FIG. 8 first, in which schematic diagrams illustrating a conversion from a serial image data to interlaced image data according to the present invention are shown. In real implementation, the serial image data coming from a baseband circuit 710 is converted into an interlaced image data. This conversion may be performed by automatically shading a half of the data, such as the odd row data or the even row data.

In addition, the serial image data may be stored in a memory 721 in a drive IC 720 previously. Thereafter, the odd number rows and the even number rows of data are rearranged to from the interlaced image data. As such, the drive IC 720 may transmit the converted interlaced image data to the liquid crystal panel 101 to be displayed. It is to be particularly pointed out that assume the baseband circuit 710 transmits the interlaced image data, the drive IC 720 may directly transmit the interlaced image data to the liquid crystal panel 101 without any conversion required. In other words.

No matter the baseband circuit 710 transmits the serial image data or the interlaced image data, the drive IC 720 may output the interlaced image data to the liquid crystal panel 101 and activate the gate and source to display the image. The serial image data may be arranged in a manner line what the serial image data 810 in FIG. 8 shows. In FIG. 8, the grid dots are the odd number row data, or odd number image data, the other portion is the even row data, or the even number image data.

In the first and third embodiments, the odd number row data or the even number row data of the serial image data 810 may be directly shaded to form the interlaced image data and then transmitted to the sources. In the second and fourth embodiments, after the serial image data 810 is converted, the serial image data 810 becomes the interlaced image data 820 such as the arrangement schematically shown in FIG. 8, wherein the first portion is the odd number row of data and the second portion is the even number row of data. In this manner, the interlacing gate drive manner may be used together to enable the odd number data to be displayed at the first half period of the signal frames and the even number data to be displayed at the second half period of the signal frames.

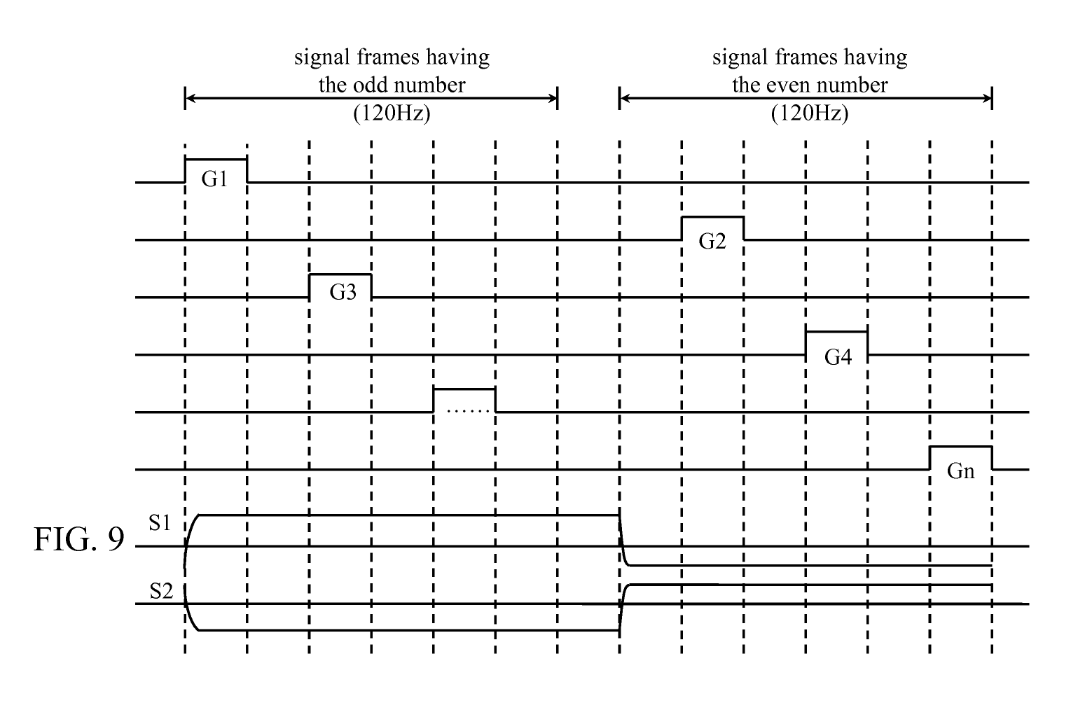

As shown in FIG. 9, a schematic diagram of a first waveform obtained by using the liquid crystal display driving method according to the present invention. In the first, the third, and the fifth embodiments, since the gates having the odd number and the even number are activated at different signal frames, respectively, an actual waveform is like what shows in FIG. 9. At the signal frames having the odd number, the gates having the odd number are activated, while the gates having the even number are activated at the signal frames having the even number. A power consumption may be obtained by the following equation:

I_{ac}=C_{LOAD}*(1)*[5V−(−5V)]*(frame-rate)*(channel-count),

wherein “C_{LOAD}” is a capacitive load of a panel data line, “frame-rate” is a frame rate, “channel-count” is a total count of the panel data line, “1” is obtained from Gn/Gn, Gn is a gate number, also a total panel scan line count. Since an output S1 has the same polarity at the same signal frames, its power consumption is largely reduced as compared to the conventional “one-dot inversion” or “two-dot inversion”. Even its frame rate increases to 120 Hz, the frame rate is only slightly larger than that of “column inversion”. The main reason is that the 120 Hz frame rate corresponds to two time data transmitted, and thus transmission of picture data consumes more power. In real implementation, the frame rate may be adjusted as desired, such as maintained as 60 Hz, adjusted to 70 Hz, or other frequencies suitable to the liquid crystal molecular. In addition, since the polarity of the sources corresponds to the arrangement of the “one-dot inversion” drive manner for frame displaying, the frame quality is superior.

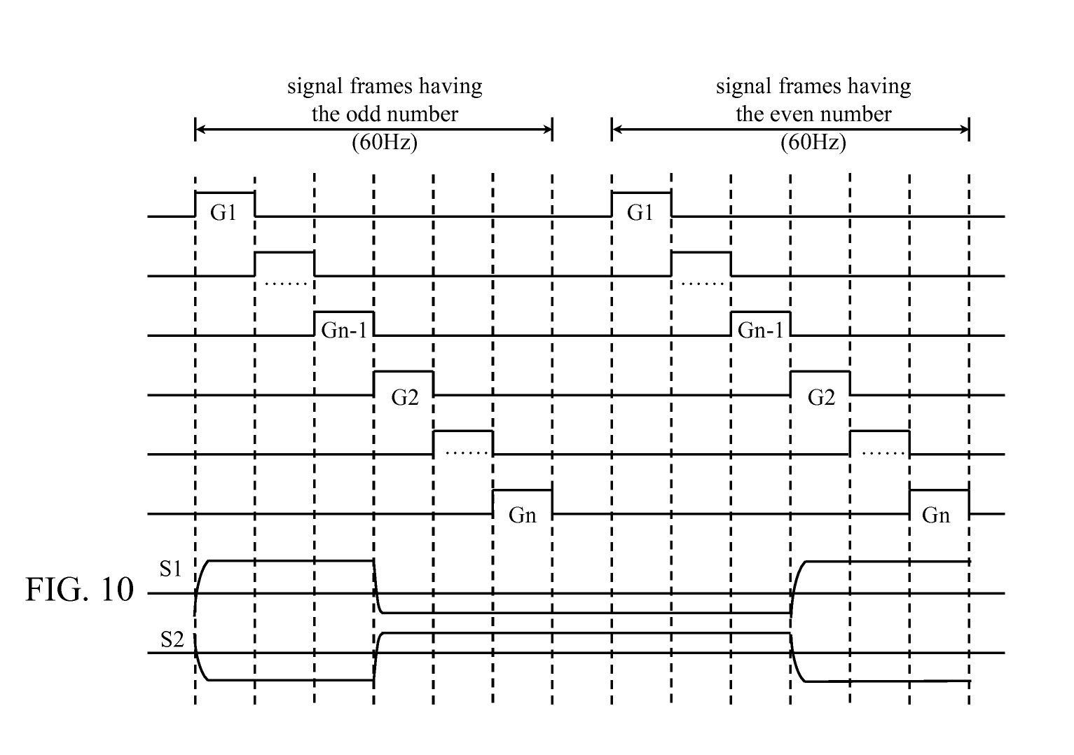

FIG. 10 is a schematic diagram of a second waveform obtained by using the liquid crystal display driving method according to the present invention.

In the second and fourth embodiments, since the gates having the odd number and the even number are driven at the first and second half periods of the same signal frame, respectively, the actual waveform is like what FIG. 10 schematically shows. At the first half period of the signal frames, the gates having the odd number are sequentially driven, such as G1, G3, G5, . . . , Gn−1. At the second half period of the signal frames, the gates having the even number are sequentially driven, such as G2, G4, G6, . . . , Gn. The power consumption may be obtained by the following equation:

I_{ac}=C_{LOAD}*(2)*[5V−(−5V)]*(frame-rate)*(channel-count),

wherein “C_{LOAD}” is the capacitive load of the panel data line, “frame-rate” is the frame rate, “channel-count” is the total count of the panel data line, is obtained from 2Gn/Gn, Gn is a gate number, also the total panel scan line count. It may be clearly seen in FIG. 10 that the polarity of the sources only inverses at the second half period of the signal frames, the alternating number is effectively reduced. At the same time, the polarity of the sources corresponds to the arrangement of the “one-dot inversion” drive manner for frame displaying, it has a superior frame quality.

In view of the above, it may be known that the method of the present invention has the difference as compared to the prior art that the interlaced image data is received or generated to generate the odd driving signal and the even driving signal, the odd number of gates and the even number of gates are driven according to the odd driving signal and the even driving signal at different signal frame periods, and the sources are driven to inverse in their polarities when the driven gates are switched from the ones having the odd number to the even number.

By busing of this technical means, the issue encountered in the prior art may be solved, and whereby achieving the efficacy of simultaneous promoted power saving and frame quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal display driving method, comprising steps of:
receiving sequentially a plurality of signal frames, each being a serial image data;
converting the serial image data into an interlaced image data;
generating an odd driving signal and an even driving signal according to the interlaced image data;
activating one of a plurality of gates having an odd number sequentially according to the odd driving signal when the plurality of signal frames have the odd number and activating one of a plurality of gates having an even number sequentially according to the even driving signal when the plurality of signal frames have the even number, wherein when the plurality of signal frames are switched from having the odd number to the even number, a plurality of sources are each driven to have an inversed polarity, respectively; and
displaying continuously the plurality of signal frames to display an image, respectively, according to a state of the plurality of gates having the odd number and the even number and the plurality of sources continuously.

2. The method as liquid crystal display driving as claimed in claim 1, wherein the step of converting the serial image data into the interlaced image data comprises a step of subjecting a masking process to an odd row data and an even row data in the serial image data.

3. The method as liquid crystal display driving as claimed in claim 1, wherein the interlaced image data is sequentially transmitted to each of the plurality of sources.

4. The method as liquid crystal display driving as claimed in claim 1, wherein the interlaced image data is transmitted by the plurality of sources, and the odd driving signal is generated at a period of the plurality of signal frames having the odd number, and the even driving signal is generated at a period of the plurality of signal frames having the even number.

5. The method as liquid crystal display driving as claimed in claim 1, wherein the odd driving signal activate one of plurality of gates having the odd number downward or upward sequentially, and the even driving signal activate one of the plurality of gates having the even number downward or upward sequentially.

6. A liquid crystal display driving method, comprising steps of:
receiving sequentially a plurality of signal frames, each being a serial image data;
converting the serial image data into an interlaced image data;
generating an odd driving signal and an even driving signal according to the interlaced image data;
activating one of a plurality of gates having an odd number sequentially according to the odd driving signal at a first half period of each of the plurality of signal frames, and activating one of a plurality of gates having an even number sequentially according to the even driving signal at a second half period of each of the plurality of signal frames, wherein when the first half period is switched to the second half period, a plurality of sources are each driven to have an inversed polarity, respectively; and
displaying continuously the plurality of signal frames to display an image, respectively, according to a state of the plurality of gates having the odd number and having the even number and the plurality of sources continuously.

7. The method as liquid crystal display driving as claimed in claim 6, wherein the step of converting the serial image data into the interlaced image data comprises a step of storing the serial image data into a memory, and rearranging an odd row data and an even row data in the serial image data in the memory into the interlaced image data.

8. The method as liquid crystal display driving as claimed in claim 7, wherein the interlaced image data within the memory is sequentially transmitted by each of the plurality of sources.

9. The method as liquid crystal display driving as claimed in claim 6, wherein the interlaced image data is transmitted by the plurality of sources, and the odd driving signal is generated at the first half period of each of the plurality of signal frames, and the even driving signal is generated at a second half period of the plurality of signal frames.

10. The method as liquid crystal display driving as claimed in claim 6, wherein the odd driving signal activate one of plurality of gates having the odd number downward or upward sequentially, and the even driving signal activate one of the plurality of gates having the even number downward or upward sequentially.

11. A liquid crystal display driving method, comprising steps of:
receiving sequentially a plurality of signal frames, each being an interlaced image data;
generating an odd driving signal and an even driving signal according to the interlaced image data;
activating one of a plurality of gates having an odd number sequentially according to the odd driving signal at the plurality of signal frames having the odd number, and activating one of a plurality of gates having an even number sequentially according to the even driving signal at the plurality of signal frames having the even number, wherein when the plurality of signal frames are switched from having the odd number to the even number, a plurality of sources are each driven to have an inversed polarity, respectively; and
displaying continuously the plurality of signal frames to display an image, respectively, according to a state of the plurality of gates having the odd number and having the even number and the plurality of sources continuously.

12. The method as liquid crystal display driving as claimed in claim 11, wherein the interlaced image data is sequentially transmitted by each of the plurality of sources, and the odd driving signal is generated at the plurality of signal frames having the odd number and the even driving signal is generated at the plurality of signal frames having the even number.

13. The method as liquid crystal display driving as claimed in claim 11, wherein the odd driving signal activate one of plurality of gates having the odd number downward or upward sequentially, and the even driving signal activate one of the plurality of gates having the even number downward or upward sequentially.

14. A liquid crystal display driving method, comprising steps of:
receiving sequentially a plurality of signal frames, each being an interlaced image data;
generating an odd driving signal and an even driving signal according to the interlaced image data;
activating one of a plurality of gates having an odd number sequentially according to the odd driving signal at a first half period of each of the plurality of signal frames, and activating one of a plurality of gates having an even number sequentially according to the even driving signal at a second half period of each of the plurality of signal frames, wherein when the first half period is switched to the second half period, a plurality of sources are each driven to have an inversed polarity, respectively; and
displaying continuously the plurality of signal frames to display an image, respectively, according to a state of the plurality of gates having the odd number and having the even number and the plurality of sources.

15. The method as liquid crystal display driving as claimed in claim 14, wherein the interlaced image data is sequentially transmitted by each of the plurality of sources, and the odd driving signal is generated at the first half period of each of the plurality of signal frames and the even driving signal is generated at the second half period of each of the plurality of signal frames.

16. The method as liquid crystal display driving as claimed in claim 14, wherein the odd driving signal activate one of plurality of gates having the odd number downward or upward sequentially, and the even driving signal activate one of the plurality of gates having the even number downward or upward sequentially.

17. A liquid crystal display driving method, comprising steps of:
receiving sequentially a plurality of signal frames each comprising a plurality of odd row image data and a plurality of even row image data;
activating one of a plurality of gates having an odd number sequentially and transmitting the plurality of odd row image data to a plurality of sources at the plurality of signal frames having the odd number, and activating one of a plurality of gates having an even number sequentially and transmitting the plurality of even row image data to the plurality of sources at the plurality of signal frames having the even number, wherein when the plurality of signal frames are switched from having the odd number to the even number, a plurality of sources are each driven to have an inversed polarity, respectively; and
displaying continuously the plurality of signal frames to display an image, respectively, according to a state of the plurality of gates having the odd number and having the even number and the plurality of sources.

18. The method as liquid crystal display driving as claimed in claim 17, wherein the step of activating one of plurality of gates having the odd number sequentially and activating one of the plurality of gates having the even number sequentially is performed downward or upward.
